(19) United States
(12) Patent Application Publication
(10) Pub. No.: US 2014/0040054 A1
(43) Pub. Date: Feb. 6, 2014

(54) HOUSING SERVICES KIOSK

(71) Applicant: Joseph Elhabr, Santa Clarita, CA (US)

(72) Inventor: Joseph Elhabr, Santa Clarita, CA (US)

(73) Assignee: Community Technology Solutions LLC, Wilmington, DE (US)

(21) Appl. No.: 13/564,579

(22) Filed: Aug. 1, 2012

(51) Int. Cl. G06Q 20/18

(52) U.S. Cl. 705/17

(57) ABSTRACT

Software and hardware enabling electronic leasing and other services for multi-family residential housing are provided. A computer kiosk can be provided in a leasing office or other location of an apartment building. The kiosk can be equipped with a display and an input device, allowing a user to interact with leasing services software running on the kiosk. The software can provide the user with secure access to information about the user's lease account. For example, the software can provide the user with information about past rent payments and current rent due. The kiosk can be equipped with a magnetic card reader and a check scanner, allowing the user to make a payment by credit card, debit card, gift card or check. Additionally, the kiosk can allow the user to make a payment with previously stored credit card or other account information.

### FIELD OF THE DISCLOSURE

This relates generally to software and hardware enabling leasing and other housing services for multi-family residential housing.

### BACKGROUND OF THE DISCLOSURE

Multi-family residential housing units are often leased to tenants for a monthly rent. Tenants are responsible for submitting rent to property managers each month. Additionally, tenants may submit maintenance requests for any problems with the housing units. Potential tenants may obtain information regarding available housing units and submit a lease application for a selected available unit. These leasing services have traditionally been provided in-person at a leasing office, for example. The payment of rent, the submission of lease applications, and other services have been conducted entirely on paper. Such a system can be inefficient, requiring the staffing of a leasing office and the manual processing of papers. Although some Internet-based leasing services have been developed, these electronic leasing services have not been widely adopted due to many potential users being accustomed to using leasing services in-person at a leasing office.

### SUMMARY OF THE DISCLOSURE

This relates to software and hardware enabling electronic leasing and other services for multi-family residential housing. A computer kiosk can be provided in a leasing office or other location of an apartment building. The kiosk can be equipped with a display and an input device, allowing a user to interact with leasing services software running on the kiosk. The software can provide the user with secure access to information about the user's lease account. For example, the software can provide the user with information about past rent payments and current rent due. The kiosk can be equipped with a magnetic card reader and a check scanner, allowing the user to make a payment by credit card, debit card, gift card or check. Additionally, the kiosk can allow the user to make a payment with previously stored credit card or other account information. In some embodiments, a reader for accepting cash can also be provided.

In some embodiments, the kiosk and the leasing software can provide a user with information about available housing units. Available housing units can be displayed according to selected criteria. For example, the software can search specifically for units available within an apartment building associated with the kiosk, or other apartment buildings being co-managed. Additionally, the software can allow the user to submit a lease application for an available housing unit, report problems within a unit or in common areas, and even post messages for retrieval by housing managers or other tenants.

Because such a kiosk can be provided in a leasing office or other common area of an apartment building, tenants and potential tenants that are accustomed to paying rent and/or submitting a lease application in person at a leasing office will find it convenient to use the electronic leasing services provided by the kiosk. In this way, the leasing services can be made more efficient by increasing the proportion of users using the electronic leasing services.

### BRIEF DESCRIPTION OF THE DRAWINGS

FIG. 1 illustrates a block diagram of an exemplary computer kiosk according to embodiments of the disclosure.

FIG. 2 illustrates an exemplary leasing services screen according to embodiments of the disclosure.

FIG. 3 illustrates an exemplary login screen according to embodiments of the disclosure.

FIG. 4 illustrates an exemplary property selection enrollment screen according to embodiments of the disclosure.

FIG. 5 illustrates an exemplary tenant information enrollment screen according to embodiments of the disclosure.

FIG. 6 illustrates an exemplary account information screen according to embodiments of the disclosure.

FIG. 7 illustrates an exemplary payment amount screen according to embodiments of the disclosure.

FIG. 8 illustrates an exemplary payment source screen according to embodiments of the disclosure.

FIG. 9 illustrates an exemplary method of accepting a rent payment according to embodiments of the disclosure.

FIG. 10 illustrates an exemplary maintenance request screen according to embodiments of the disclosure.

FIG. 11 illustrates an exemplary unit listing screen according to embodiments of the disclosure.

FIG. 12 illustrates an exemplary basic information application form according to embodiments of the disclosure.

FIG. 13 illustrates an exemplary unit information application form according to embodiments of the disclosure.

FIG. 14 illustrates an exemplary additional information application form according to embodiments of the disclosure.

FIG. 15 illustrates an exemplary financial information application form according to embodiments of the disclosure.

FIG. 16 illustrates an exemplary people information application form according to embodiments of the disclosure.

FIG. 17 illustrates an exemplary contact information application form according to embodiments of the disclosure.

FIG. 18 illustrates an exemplary payment application form according to embodiments of the disclosure.

### DETAILED DESCRIPTION

In the following description of embodiments, reference is made to the accompanying drawings which form a part hereof, and in which it is shown by way of illustration specific embodiments that can be practiced. It is to be understood that other embodiments can be used and structural changes can be made without departing from the scope of the disclosed embodiments.

Various embodiments relate to software and hardware enabling electronic leasing and other services for multi-family residential housing. A computer kiosk can be provided in a leasing office or other location of an apartment building. The kiosk can be equipped with a display and an input device, allowing a user to interact with leasing services software running on the kiosk. The software can provide the user with secure access to information about the user's lease account. For example, the software can provide the user with information about past rent payments and current rent due. The kiosk can be equipped with a magnetic card reader and a check scanner, allowing the user to make a payment by credit card, debit card, gift card or check. Additionally, the kiosk can allow the user to make a payment with previously stored credit card or other account information. In some embodiments, a reader for accepting cash can also be provided.

In some embodiments, the kiosk and the leasing software can provide a user with information about available housing units. Available housing units can be displayed according to selected criteria. For example, the software can search specifically for units available within an apartment building associated with the kiosk, or other apartment buildings being co-managed. Additionally, the software can allow the user to submit a lease application for an available housing unit, report problems within a unit or in common areas, and even post messages for retrieval by housing managers or other tenants.

Because such a kiosk can be provided in a leasing office or other common area of an apartment building, tenants and potential tenants that are accustomed to paying rent and/or submitting a lease application in person at a leasing office will find it convenient to use the electronic leasing services provided by the kiosk. In this way, the leasing services can be made more efficient by increasing the proportion of users using the electronic leasing services.

Although embodiments disclosed herein may be described and illustrated herein primarily in terms of multi-family residential housing, it should be understood that the embodiments are not so limited, but are additionally applicable to other types of real estate, including commercial real estate and single-family housing. Although embodiments disclosed herein may be described and illustrated herein in terms of a computer kiosk in a leasing office, it should be understood that embodiments are not so limited, but are additionally applicable to other general-purpose computers.

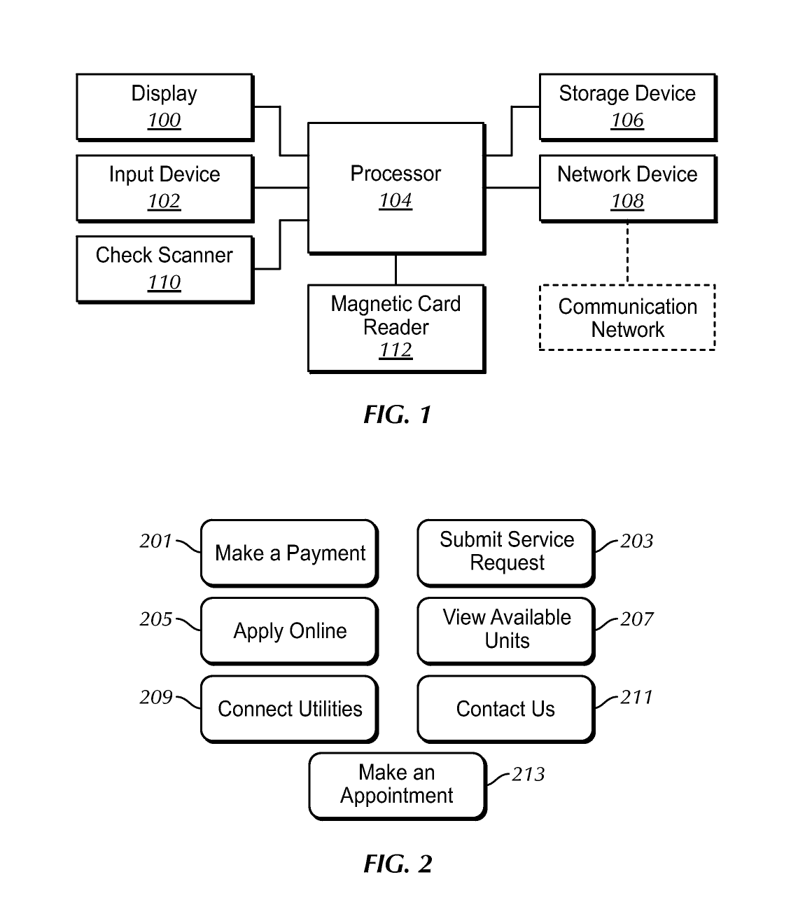

FIG. 1 illustrates a block diagram of an exemplary computer kiosk according to embodiments of the disclosure. The kiosk can have a display 100 and an input device 102, each coupled to a processor 104. A storage device 106 can store leasing software or other software. The kiosk can have a network device 108 that provides connection to a communication network, such as the internet. In some embodiments, some or all of the leasing software can be stored in a storage device remote from the kiosk, and the kiosk can interact with the leasing software remotely through the network device 108.

The input device 102 can include a textual input device, such as a keyboard. Additionally, the input device 102 can include a pointing device, such as a mouse or track pad. In some embodiments, the input device 102 can be a touch panel coupled with the display 100 to form a touchscreen. The input device 102 can allow a user to interact with the leasing software or other software. For example, a pointing device or touch screen can allow a user to select options displayed on the display 100, and a keyboard can allow a user to input text into a field displayed on the display. In other embodiments, the input device 102 can recognize voice input.

The kiosk can further include a check scanner 110 and a magnetic card reader 112. Although not shown, cash readers may also be employed. Each of these devices can allow a user to make a payment using the kiosk. The check scanner 110 can obtain a digital image of a check supplied by a user. The scanner 110 can then use optical character recognition (OCR) technology to recognize text and numbers from the digital image and store the text and numbers as payment information. Such payment information can include account and routing numbers, payment amount, and payment recipient. Similarly, the magnetic card reader 112 can obtain credit card account information stored on a magnetic strip of a credit card supplied by a user.

The display 100 can display a series of interactive screens and forms, as illustrated in FIGS. 2-8 and 10-18. Additionally, a user can use the input device 102 to select from options on each screen and input text into text fields on each screen.

FIG. 2 illustrates an exemplary leasing services screen according to embodiments of the disclosure. The user can choose among multiple services listed on the leasing services screen. The listed services can include: “Make a Payment” 201, which can allow a user to submit a rent payment; “Submit Service Request” 203, which can allow a user to submit a request for maintenance services; “Apply Online” 205, which can allow a user to submit a lease application; “View Available Units” 207, which can allow a user to search and view information regarding vacant apartments; “Connect Utilities” 209, which can allow a user to view the website of a utilities provider; “Contact Us” 211, which can allow a user to send an email to a property manager; and “Make an Appointment” 213, which can allow a user to schedule an appointment with a property manager.

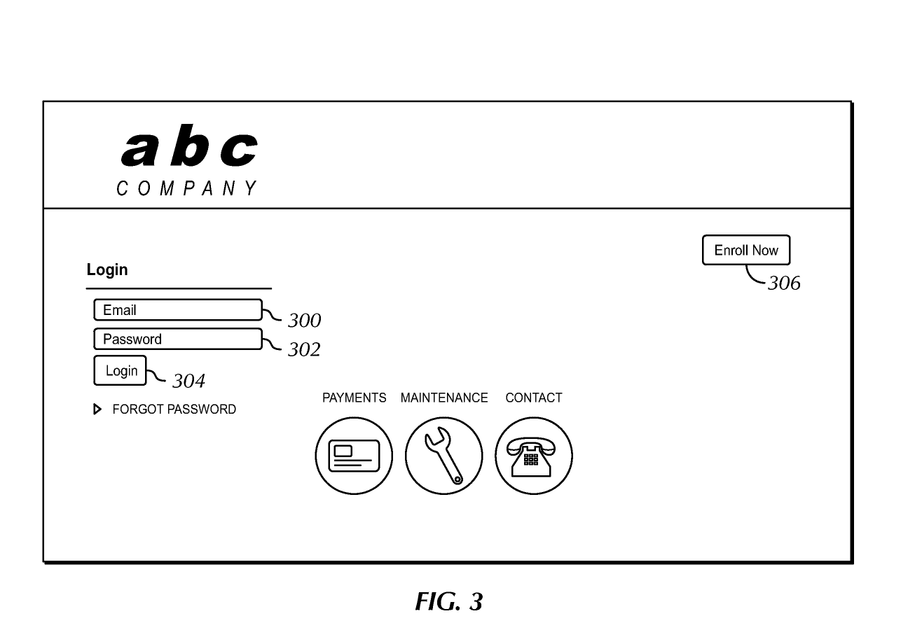

FIG. 3 illustrates an exemplary login screen according to embodiments of the disclosure. Certain services, such as paying rent and submitting a service request, may be associated with a particular tenant account. As such, the software may require that a user login with credentials before accessing those services. Credentials can include an email address and a password associated with that email address. The login screen can have a text field for each of email address 300 and password 302. The user can type an email address in the email address text field 300 and a password in the password text field 302. The login credentials can be submitted when the user selects the login button 304. The login credentials can then be verified by a login module that can associate the credentials with a particular tenant account. In some embodiments the login module can be stored remote from the kiosk, and the credentials can be transmitted through the network device for verification. Upon verification, the user can access the services that are associated with that tenant account.

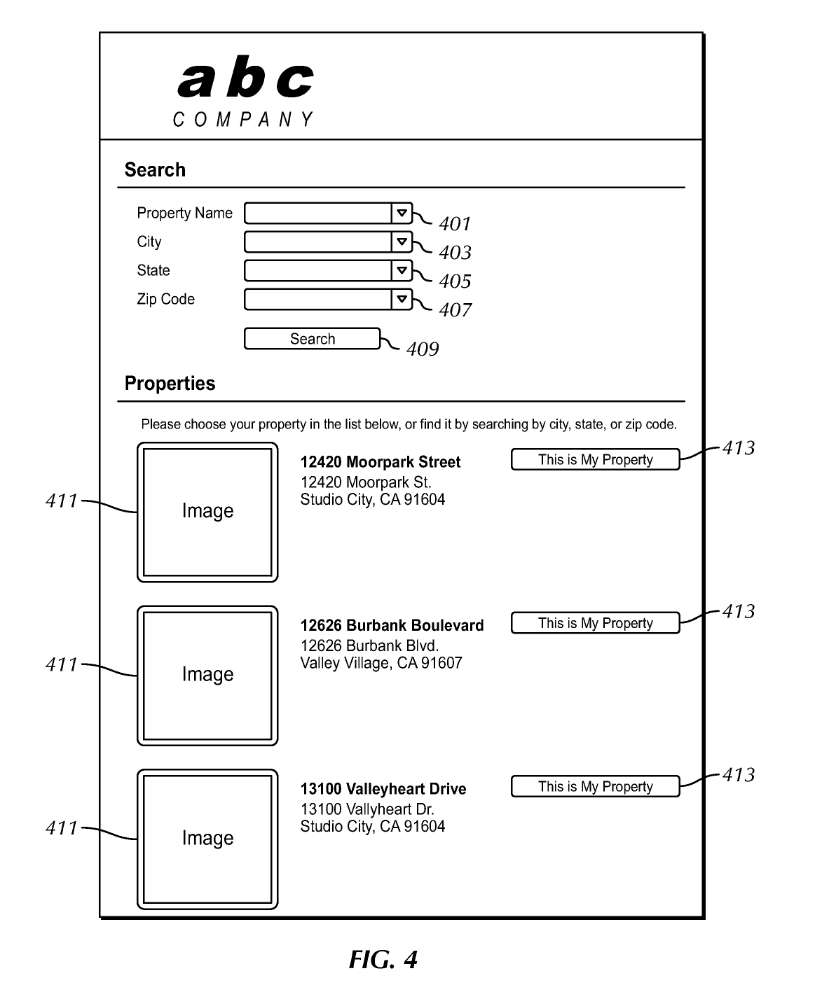

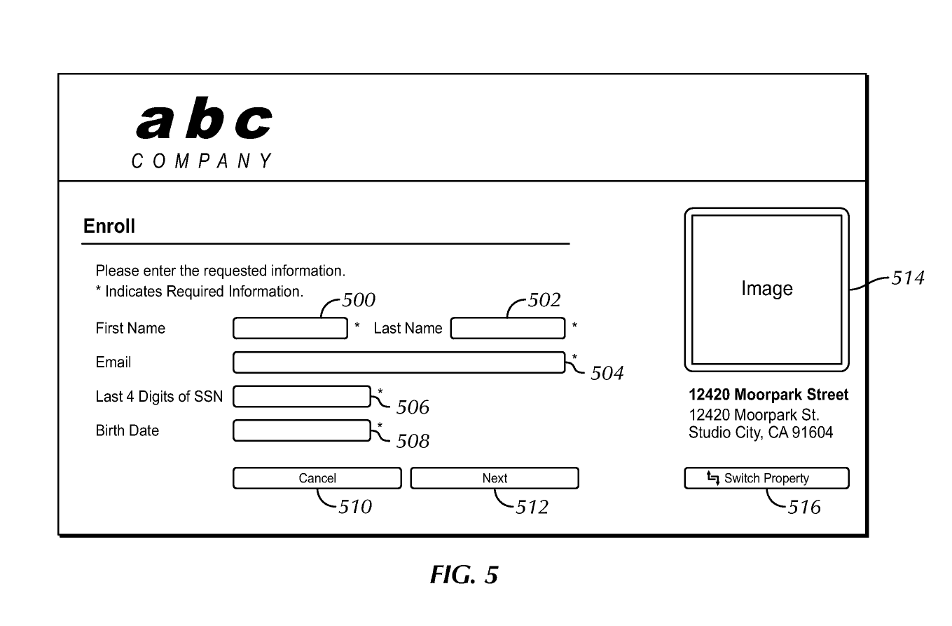

A user that has not yet obtained login credentials for his or her account can obtain login credentials by selecting the enrollment button 306. Once the enrollment button 306 is selected, the user can obtain credentials by selecting a property as illustrated in FIG. 4 and then providing tenant information as illustrated in FIG. 5.

FIG. 4 illustrates an exemplary property selection enrollment screen according to embodiments of the disclosure. The property selection enrollment screen can allow a user to choose the property in which he or she is a tenant. The user can search for the property by property name 401, city 403, state 405, and/or zip code 407 using various input fields. A search can be submitted using the search button 409. Property information 411 can be displayed for each property. Property information can include a photo of the property, an address, and other descriptive information. Additionally, a property selection button 413 can be displayed for each property. The user can select a property by selecting the property selection button associated with that property. In some embodiments, the kiosk can be associated with the property in which it is located. Accordingly, the associated property can be automatically selected as a default for enrollment.

FIG. 5 illustrates an exemplary tenant information enrollment screen according to embodiments of the disclosure. The tenant information enrollment screen can allow the tenant to enter personally identifying information so that the software can identify the tenant and verify the tenant's identity. The user can enter information such as first name 500, last name 502, email address 504, some or all of a social security number 506, and a birth date 508. The information can be submitted by selecting the submission button 512. After submission, the user can be provided with login credentials. Alternatively, the user can select the cancel button 510 to cancel the enrollment process. Additionally, information 514 can be displayed regarding the currently selected property. The user can select the switch property button 516 to return to the property selection enrollment screen to choose a different property. Upon submission, the information entered by the user can be verified by a login module and then a password can be assigned to the user.

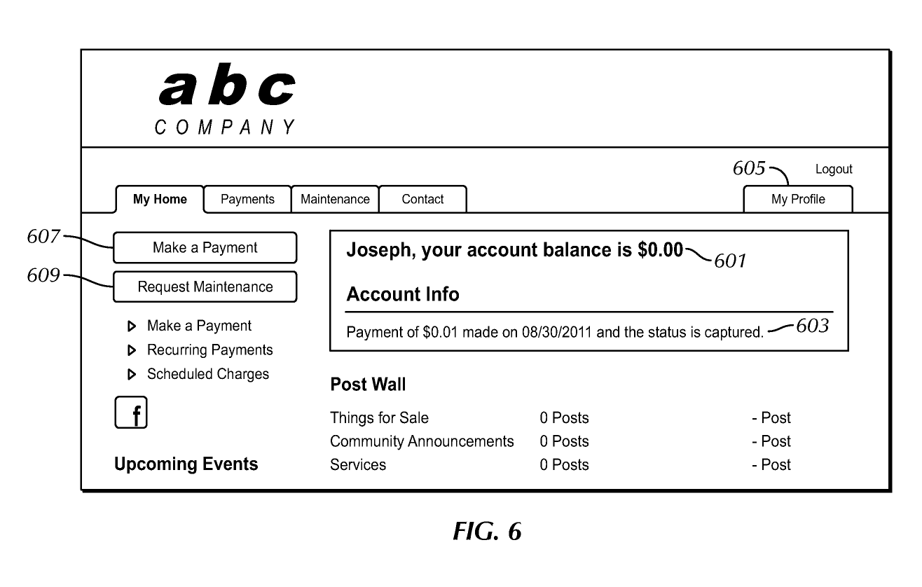

FIG. 6 illustrates an exemplary account information screen according to embodiments of the disclosure. The account information screen can display information such as an account balance 601 and a payment status 603. In some embodiments, the account information screen can display tenant information, property information, and further information regarding previous payments. In other embodiments, such information can be displayed on a separate profile screen, accessible through a profile button 605. In some embodiments, the account information screen can display a past due notice if the current date is later than a due date of the account balance. The account information screen can also have a payment button 607 and a maintenance request button 609 to provide the user quick access to those services.

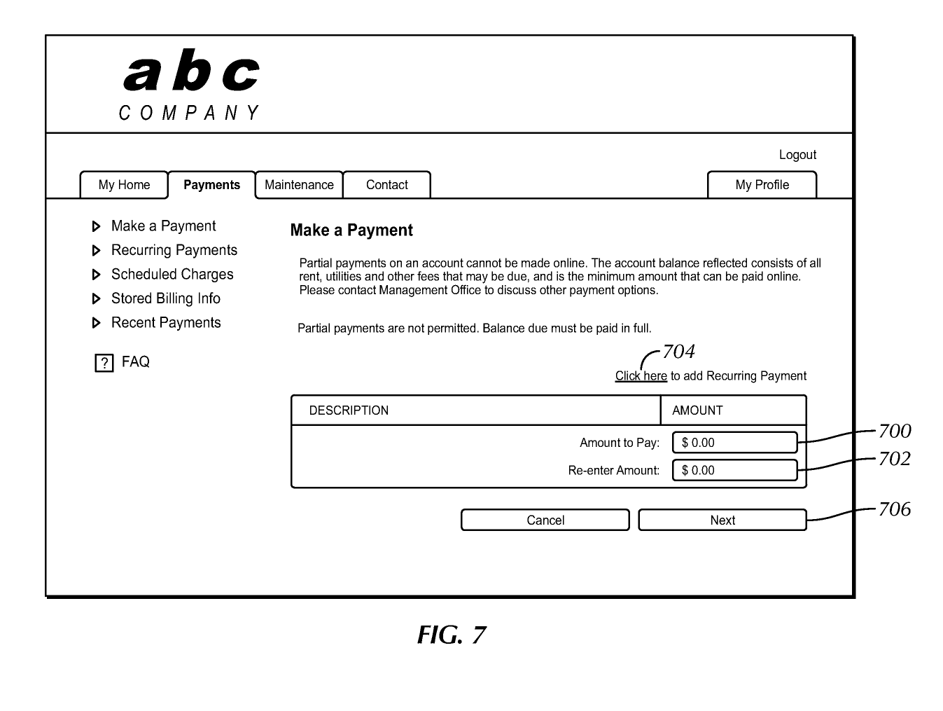

FIG. 7 illustrates an exemplary payment amount screen according to embodiments of the disclosure. The payment amount screen can allow a user to enter a desired payment amount into an amount field 700 and a re-entry field 702. The values entered in the amount field 700 and the re-entry field 702 can be compared to ensure that the user entered the intended payment amount. Additionally, a user can setup recurring payments by selecting the recurring payment link 704. The entered payment amount can be submitted by selecting the next button 706.

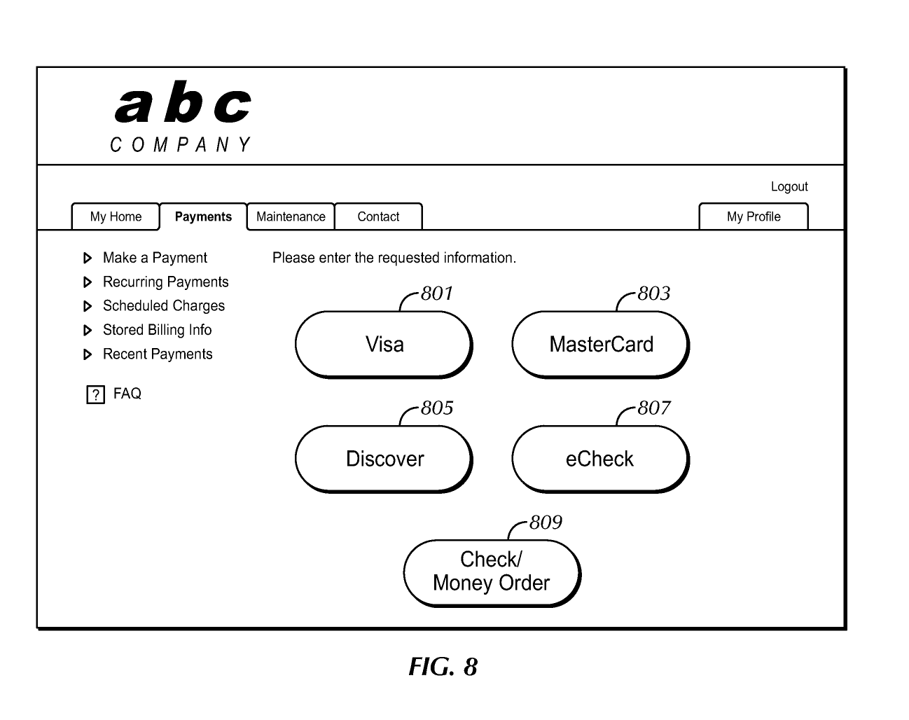

FIG. 8 illustrates an exemplary payment source screen according to embodiments of the disclosure. The payment source screen can allow a user to choose a source to fund a payment. Payment sources can include credit cards such as Visa 801, MasterCard 803, and Discover 805. Additionally, a user can pay by eCheck 807 or by check/money order 809, or cash. If a user selects a credit/debit/gift card option 801-805, the user can be prompted to swipe a credit card through the magnetic card reader to submit the credit card account information. If a user selects the eCheck option 807, the user can be prompted to enter eCheck account information. If a user selects the check/money order option 809, the user can insert a check or money order into the check scanner to submit the checking account or money order information. Although not shown, the selection of a cash option can allow a user to insert cash into a cash reader.

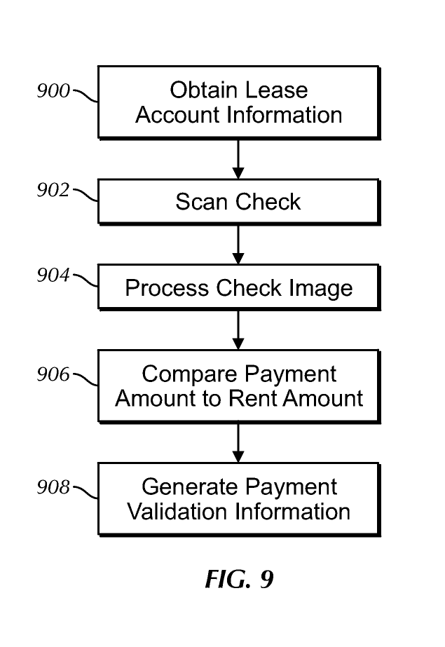

FIG. 9 illustrates an exemplary method of accepting a rent payment according to embodiments of the disclosure. First, at step 900, lease account information can be obtained. Lease account information can include an account balance or a rent amount currently due. The lease account information can be obtained based on login credentials supplied by a user, as in FIG. 3. Next, at step 902, a check can be scanned, for example, by the check scanner. The check scanner can capture an image of the surface of the check. At step 904, the check image can be processed. The check image can be processed using OCR technology to recognize text and numbers from the digital image and store the text and numbers as payment information. Such payment information can include account and routing numbers, payment amount, and payment recipient. At step 906, the payment amount captured from the processed check image can be compared to the account balance or to the rent amount currently due obtained from the lease account information. Additionally, the payment recipient from the check can be compared to a name of an authorized payment recipient, to ensure that the check can be cashed by the property management entity. If the payment amount is sufficient to discharge the account balance or the rent amount currently due, then payment validation information can be generated at step 908. The payment validation information can indicate that the tenant has submitted sufficient payment to meet his or her obligation. The payment validation information can be stored locally or sent over the communication network to indicate to the property manager that the tenant's account is current. Additionally, the payment validation information can further indicate that, although the sufficient amount was submitted on the check, the check must clear before the payment is fully validated.

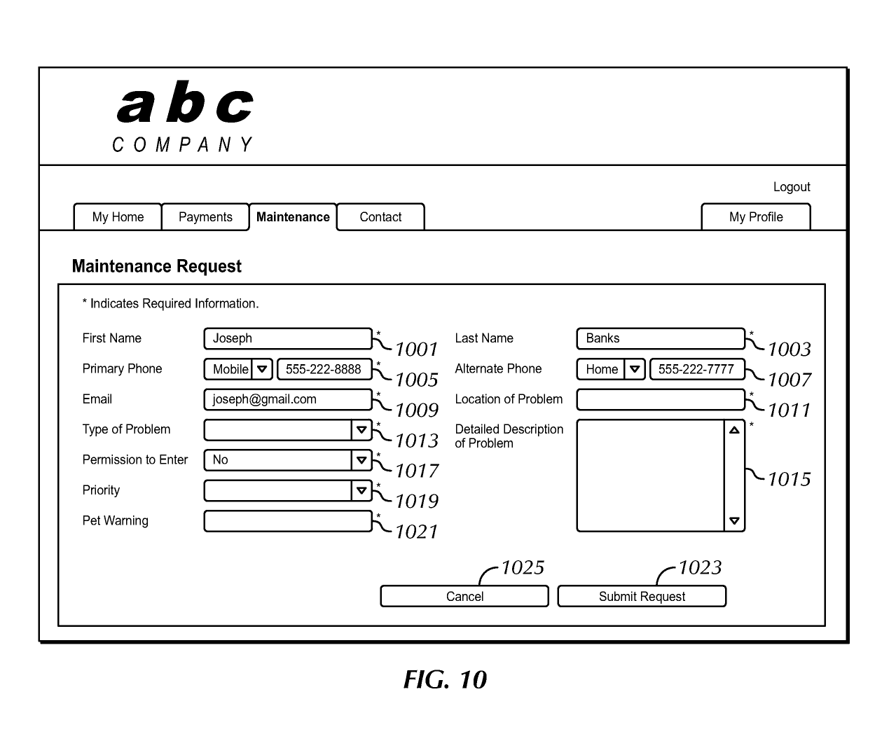

FIG. 10 illustrates an exemplary maintenance request screen according to embodiments of the disclosure. The maintenance request screen can allow the user to input tenant information such as first name 1001, last name 1003, primary phone 1005, alternate phone 1007, and email address 1009. Additionally, the maintenance request screen can allow the user to enter information about the maintenance request, including the location of the problem 1011, the type of problem 1013, a detailed description of the problem 1015, whether a property manager has permission to enter 1017, the priority of the problem 1019, and a pet warning 1021. By selecting the submission button 1023, the information entered by the user can be sent directly to a property manager by email. In some embodiments, the priority level indicated can determine who is contacted and by what means. For example, a very high priority request might generate an automated phone call to a senior property manager.

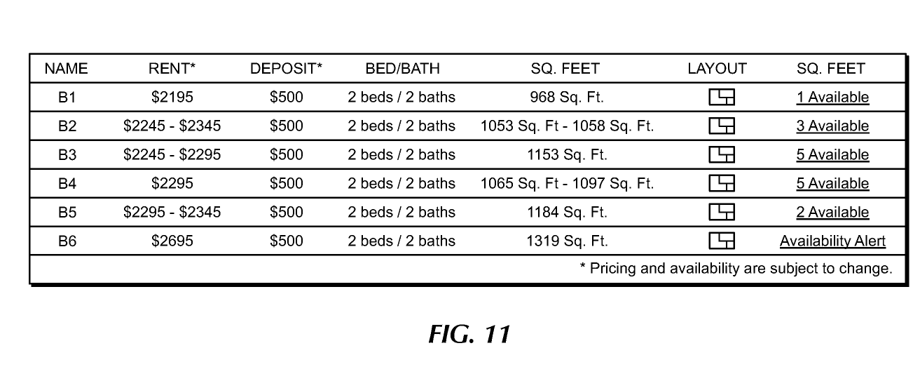

FIG. 11 illustrates an exemplary unit listing screen according to embodiments of the disclosure. The unit listing screen can list information regarding available units in the apartment building associated with the kiosk. In some embodiments, the unit listing screen can list information regarding available units according to search criteria specified by the user, such as a zip code or apartment size. The information for each unit can include rent amount, deposit amount, number of bedrooms, number of bathrooms, apartment size, and number of available units. Additionally, each available unit can have a link to a lease application for that unit. In some embodiments unavailable units can be listed with a link to an availability alert form, allowing the user to submit contact information so that he or she may be contacted if the unit becomes available.

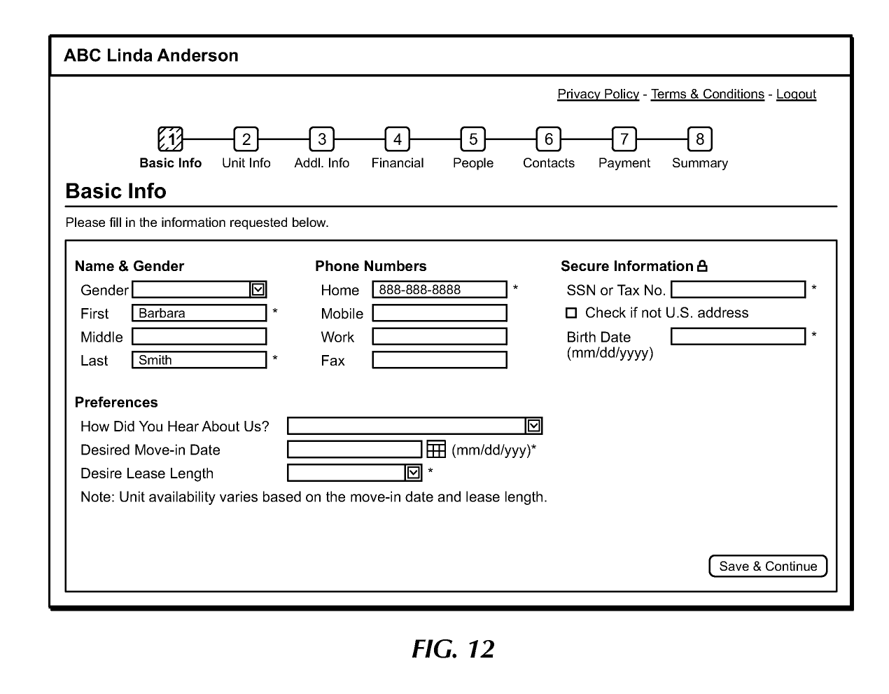

FIG. 12 illustrates an exemplary basic information application form according to embodiments of the disclosure. The basic information application form can allow a user to provide identification and contact information for the lease application.

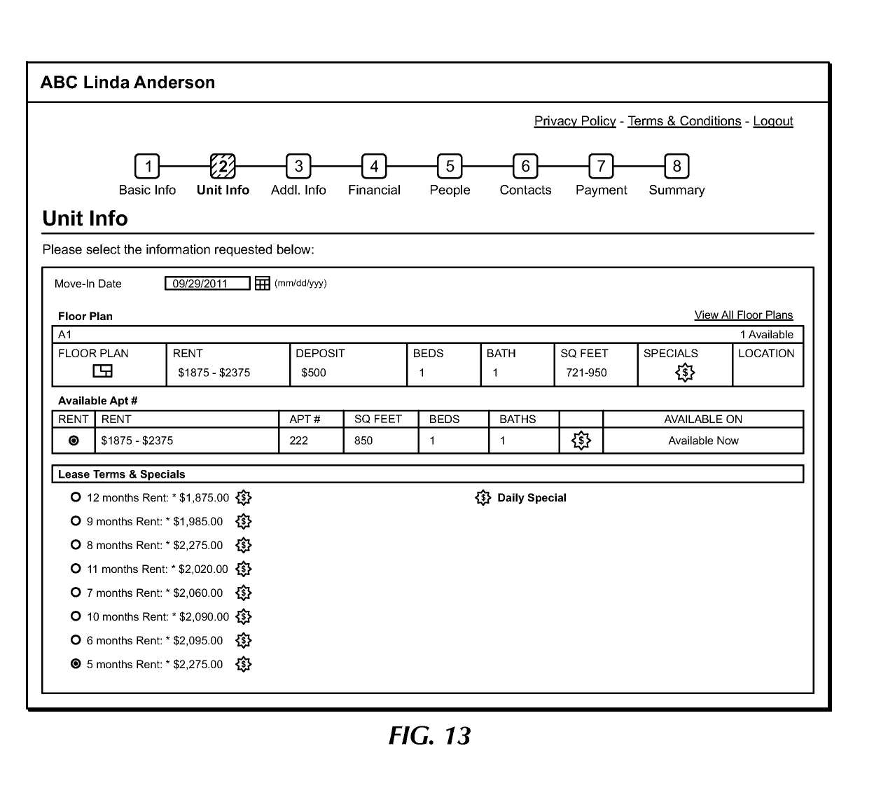

FIG. 13 illustrates an exemplary unit information application form according to embodiments of the disclosure. The unit information application form can allow a user to designate the term of the lease. In some embodiments, each term choice can correspond to a different monthly rent amount.

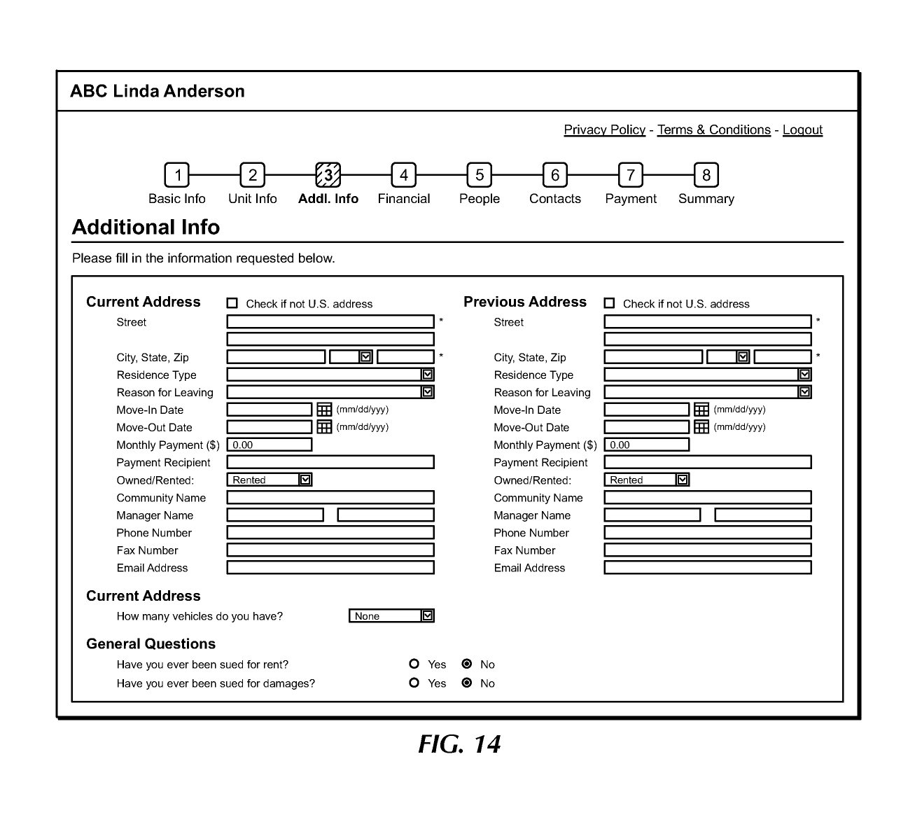

FIG. 14 illustrates an exemplary additional information application form according to embodiments of the disclosure. The additional information application form can allow a user to submit other general information, such as previous addresses and vehicle information.

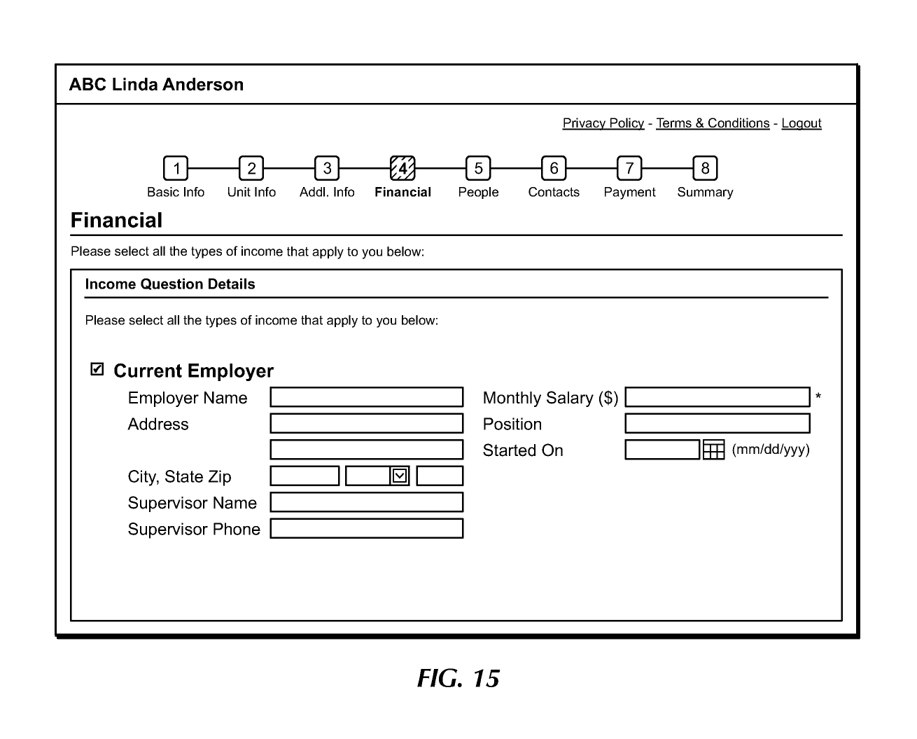

FIG. 15 illustrates an exemplary financial information application form according to embodiments of the disclosure. The financial information application form can allow a user to submit financial information, such as information regarding employment and salary.

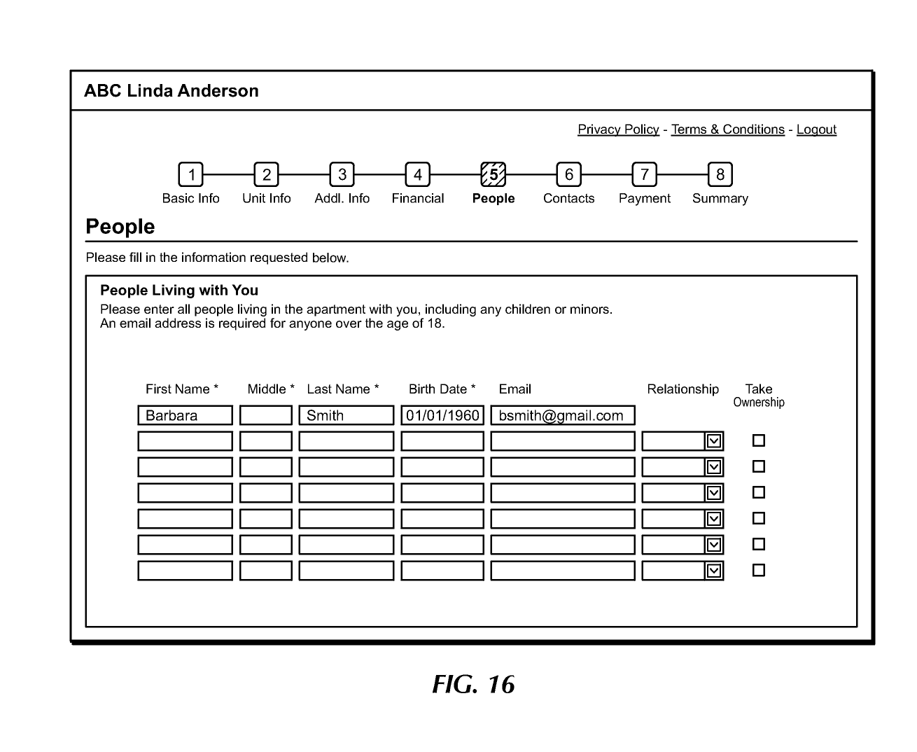

FIG. 16 illustrates an exemplary people information application form according to embodiments of the disclosure. The people information application form can allow a user to submit information about potential tenants that would share the selected unit with the applicant. The tenant information can include name, birth date, email address, and the relationship to the applicant.

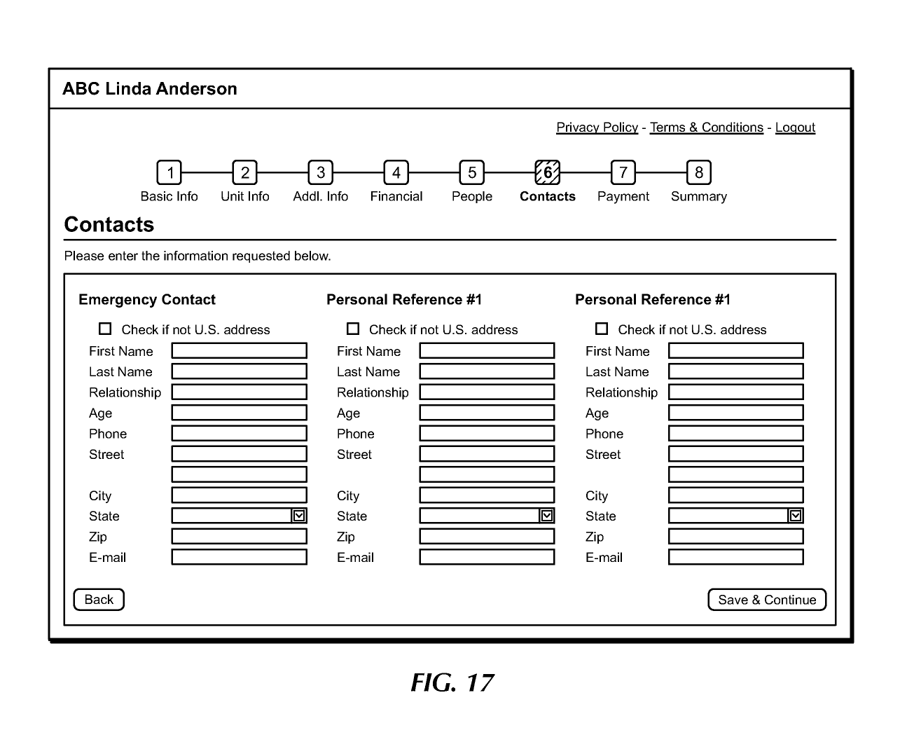

FIG. 17 illustrates an exemplary contact information application form according to embodiments of the disclosure. The contact information application form can allow a user to designate an emergency contact and one or more personal references as part of the lease application. Personal information and contact information can be supplied for each of the contacts.

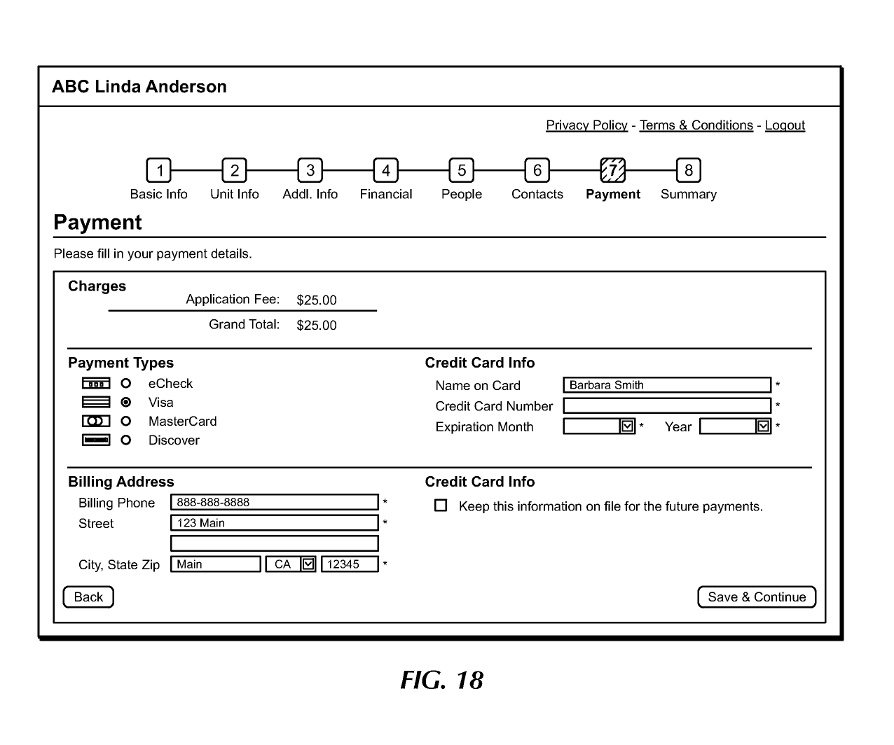

FIG. 18 illustrates an exemplary payment application form according to embodiments of the disclosure. The payment application form can allow a user to submit payment information to process payment of the application fee. As with the rent payment system, the user can choose from several payment sources, including credit card, debit card, gift card, cash, eCheck, check, and money order. If a user chooses to pay by credit/debit/gift card, the kiosk can accept a card payment through the magnetic card reader. If a user chooses to pay by check or money order, the kiosk can accept the check or money order through the check scanner. Alternatively, the user can manually enter credit card or eCheck information as illustrated in FIG. 18, or submit cash to a cash reader.

Upon submission of the various application forms, the information can be sent to a property manager through email for review. Upon approval of the application, the tenant information submitted with the application form can be stored and later used to verify the tenant identity upon enrollment as in FIG. 5.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

1. A housing services kiosk comprising:
a display that displays account information;
an input device that accepts account login information from a user;
a network device that transmits payment account information;
a magnetic card reader that accepts payment account information from the user;
a check scanner that accepts payment account information from the user; and
one or more processors capable of:
processing a digital representation of a check image obtained by the check scanner to obtain a payment amount,
comparing an amount due to the payment amount,
based on the comparison, determining that the payment amount is no less than the amount due, and
based on the determination, generating payment validation information and transmitting the payment validation information via the network device.

2. The kiosk of claim 1, wherein payment account information includes one or more of a card number, a payment amount, an account number, and a routing number.

3. The kiosk of claim 1, wherein lease account information includes one or more of a tenant name, a rent amount, and an account balance.

4. The kiosk of claim 1, wherein the display further displays available unit information; and
wherein the input device further accepts lease application information from the user.

5. The kiosk of claim 4, wherein the network device further transmits the lease application information submitted by the user.

6. The kiosk of claim 1, wherein the input device further accepts maintenance request information from the user.

7. The kiosk of claim 1, wherein the input device further accepts contact information and a selection of an unavailable unit from the user; and
wherein the network device further transmits unit availability alert information, including the contact information and the selected unavailable unit.

8. The kiosk of claim 1, wherein the lease account login information includes an email address and a password; and
wherein the network device further transmits the lease account login information for verification and receives login verification information.

9. The kiosk of claim 1, wherein the input device further accepts lease account enrollment information from a user.

10. A computer-implemented method for accepting rent payment, the method comprising:
obtaining lease account information, including an amount due, and storing the amount due in a computer readable medium;
scanning a check, with an image scanner, to obtain a digital representation of a check image; and
at one or more processors,
processing the digital representation of the check image using optical character recognition to obtain payment information, including a payment amount, and storing the payment amount in a computer readable medium,
comparing the stored amount due to the stored payment amount,
based on the comparison, determining that the payment amount is no less than the amount due, and
based on the determination, generating payment validation information and transmitting the payment validation information via a network device.

11. The method of claim 10, further comprising:
obtaining lease account login information from a user; and
verifying the lease account login information;
wherein the lease account information is obtained based on the lease account login information.

12. The method of claim 10, further comprising:
obtaining lease account enrollment information from a user; and
creating lease account login information based on the lease account enrollment information.

13. The method of claim 12, wherein the lease account enrollment information includes personally identifying information and property information.

14. The method of claim 10, wherein the lease account information further includes a due date, the method further comprising:
comparing the due date to a current date; and
displaying a past due notice if the current date is later than the due date.

15. The method of claim 10, the payment information further includes a payment recipient, an account number, and a routing number.

16. The method of claim 15, further comprising comparing the payment recipient to a name of an authorized recipient.
